(19) United States
(12) Patent Application Publication
(10) Pub. No.: US 2006/0184730 A1
(43) Pub. Date: Aug. 17, 2006

(54) Drive based sector initialization

(76) Inventors: Joanna K. Brown, Winchester (GB); Paul Hooton, Eastleigh (GB); Karl A. Nielsen, Tucson, AZ (US); Richard A. Ripberger, Tucson, AZ (US)

Correspondence Address: QUARLES & BRADY STREICH LANG LLP, 1 SOUTH CHURCH AVENUE, SUITE 1700, TUCSON, AZ, 85701, US

(21) Appl. No.: 11/057,292

(22) Filed: Feb. 11, 2005

(51) Int. Cl. G06F 13/00

(52) U.S. Cl. 711/113

(57) ABSTRACT

A data storage system includes a host computer, a data storage device, and a communication bus connecting the host computer to the data storage device. The host computer is adapted to issue a specialized initiation command, such as a format command with a unique parameter or a unique send diagnostic command. Once received by the data storage device, the specialized initiation command is decoded by a command processor which, in turn, directs a memory controller to execute an internal initiation of target sectors residing on data storage media within the data storage device. The memory controller places sector data in a temporary memory device, such as a random-access memory (“RAM”), including a plurality of zeroes appended to a logical redundancy check (“LRC”) value. Once compiled, this sector data is written to the data storage media. In this way, target sectors of the data storage media are initialized with LRC information without requiring large amounts of data being transmitted over the communication bus.

### BACKGROUND OF THE INVENTION

1. Field of the Invention

This invention is related in general to the field of data storage systems. In particular, the invention consists of a system for initializing sectors of a data storage device with logical redundancy check information without transmitting extensive information over a communication bus.

2. Description of the Prior Art

Data storage systems 10, such as the one exemplified in FIG. 1, may include one or more host computers 12 connected to one or more data storage devices 14 over a communication bus 16. This communication bus 16 may be a small-computer systems interface (“SCSI”) bus, a fibre channel bus, or any other communication known in the art. The host computers 12 may include general-purpose central processing units (“CPUs”), data storage servers, or computers adapted to be interfaced with remote client computers.

The data storage devices 14 may include hard disk drives, magneto-optical drives, floppy disk drives, tape cartridges, or other memory device. In a traditional data storage system, these data storage devices 14 may be grouped together as a redundant array of independent/inexpensive disks (“RAID”). Typically, the data storage devices 14 are segregated into sectors, with each sector traditionally containing a set number of bytes of information. Additionally, in a RAID system, it is desirable to maintain parity information across each array in order to ensure integrity of data written to the data storage devices 14. However, before a data storage device 14 can be used, it is traditionally initialized.

One method of initialization includes segregating the data storage devices into sectors and writing binary values to the sectors. One method is to format each data storage device with all zeroes. This is beneficial in that parity for associated RAIDs do not need to be rebuilt. Another method is to format each drive with data other than zeroes, but have each sector contain the same information. However, it is desirable to have a means of initializing data storage devices in a way that does not require rebuilding parity for associated RAIDs but provides logical redundancy checking (“LRC”).

In one exemplary initialization, the first 522 bytes of a 524 byte sector is written to with all zeroes. Two bytes of the sector's logical block address (“LBA”) is written to the last two bytes in order to provide LRC. Traditionally, data written to a data storage device, including initialization information, is transmitted by the host computer 12, through the communication bus 16, to the data storage device. A problem occurs, however, when initializing large numbers of data storage devices containing large numbers of sectors.

In a data storage system 10 having a bandwidth of 100 MB/sec and a write-through speed of 50 MB/sec for each data storage device, initializing a large number of data storage devices would saturate the bandwidth capacity of the communication bus 16. In this example, the bandwidth of the communication bus would be fully utilized during initialization of only two data storage devices, leaving no excess bandwidth for normal communication between the host computers 12 and other data storage devices 14. In an exemplary data storage system 10, up to eight data storage devices are initialized at once. This results in an extensive bottleneck of the communication bus that drastically reduces the ability of the data storage system 10 to accommodate customer input/output requests arriving via the host computer 12. Accordingly, it is desirable to have a means for initializing data storage devices 14 without transmitting extensive amounts of information over the communication bus.

### SUMMARY OF THE INVENTION

The invention disclosed herein utilizes a command processor, a memory controller, and a memory device to receive an initialization command from a host computer, to generate logical redundancy check (“LRC”) information, combine the LRC information with zeroes, and write the resulting combination to each sector of a data storage device. Integral to the invention is a specialized initialize command originating from the host computer that initiates this process. This specialized initialize command may be an extension of a traditional format command, i.e., a format command with special parameters. Alternatively, a write same command or send diagnostic command may be used, so long as the data written to the data storage device is generated internal to the data storage device.

In one embodiment of the invention, the command processor directs the memory controller to prepare an area of random-access memory (“RAM”) with sets of zeroes and an LRC for each sector that is to be initialized. Here, the LRC is simply the least two significant bytes of the logical block address (“LBA”) for each sector to be written to. Once the sets of initialization information have been staged in the RAM, the memory controller simply transfers this information to the physical surface of the data storage media that will retain the information.

In another embodiment of the invention, the memory controller includes an address of a memory location that contains zeroes. The RAM is simply configured with sequential LRCs. A write channel, using a scatter/gather list, simply combines the zeroes from the location indicated by the address in the memory controller and combines them with the LRC from the RAM. In both embodiments of the invention, data is written to the data storage media in basically the same way that a normal write operation would be performed, except that the written data does not originate at the host computer and is not transmitted over the communication bus. Once the initialization procedure has completed, a notification is transmitted by the command processor back to the host computer to indicate either success or failure.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram illustrating an exemplary data storage system including a host computer, a communication bus, and a data storage device.

FIG. 2 is a block diagram illustrating a data storage system, according to the invention, including a host computer, a communication bus, and a data storage device.

FIG. 3 is a block diagram illustrating a data storage device, according to the invention, including a command processor, a memory controller, a random access memory (“RAM”) device, a write channel, and physical data storage media.

FIG. 4 is a flow chart illustrating a process of initializing a data storage device according to the invention.

### DESCRIPTION OF THE PREFERRED EMBODIMENTS

This invention is based on the idea of using a specialized initialization instruction to direct a command processor residing within a data storage device to generate initialization information including logical redundancy check (“LRC”) information specific to each sector of a data storage media being written to. The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices.

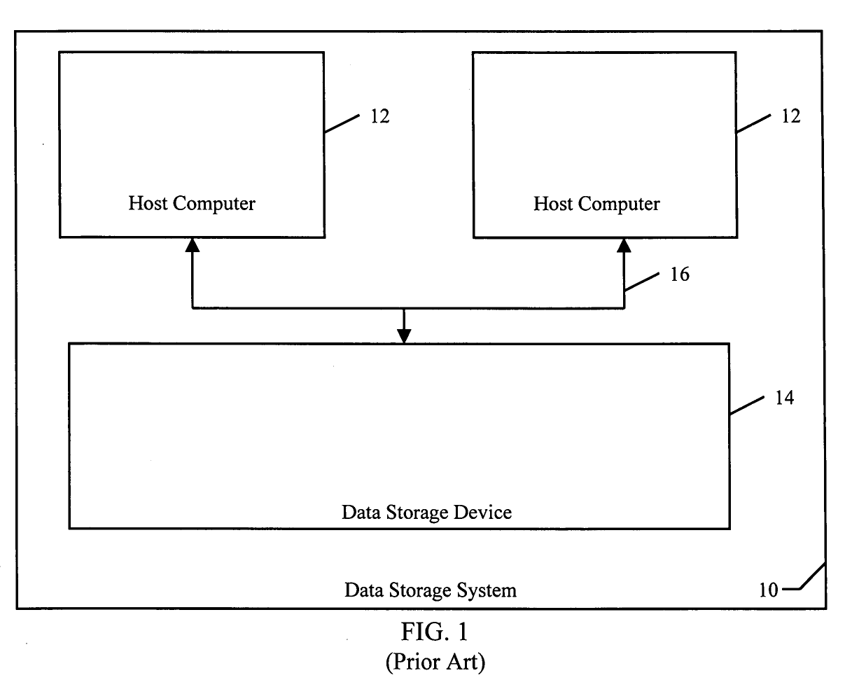

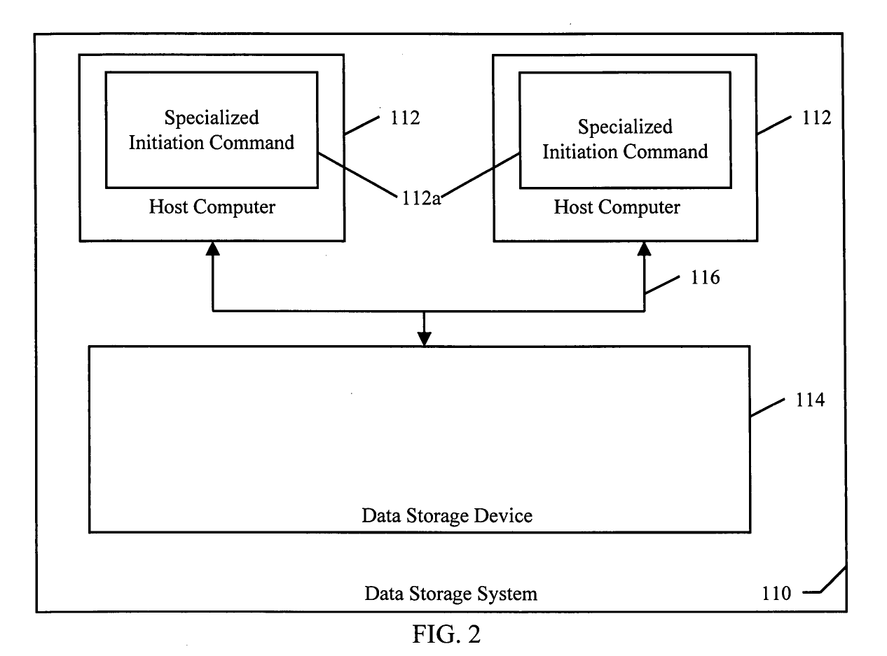

Referring to figures, wherein like parts are designated with the same reference numerals and symbols, FIG. 2 is a block diagram illustrating a data storage system 110, according to the invention, including a host computer 112, a data storage device 114, and a communication bus 116 connecting the host computer to the data storage device. The data storage device 114 differs from a traditional data storage device 14 (FIG. 1) in that it is adapted to receive initialization instructions from the host computer 112 and initialize internal data storage media without requiring that all initialization information arrive via the communication bus 116. In this embodiment of the invention, the data storage device is a hard disk drive, but the invention may be applied to any type of data storage device. Additionally, the host computer 112 differs from a traditional host computer 12 (FIG. 1) in that it has been adapted to generate a specialized initiation command 112a. This command may take the form of a traditional format instruction with an additional extension that instructs the command processor to implement an internal initialization. Alternatively, the specialized initiation command 112a may be a write same command with parameters, or it may be a unique send diagnostic command.

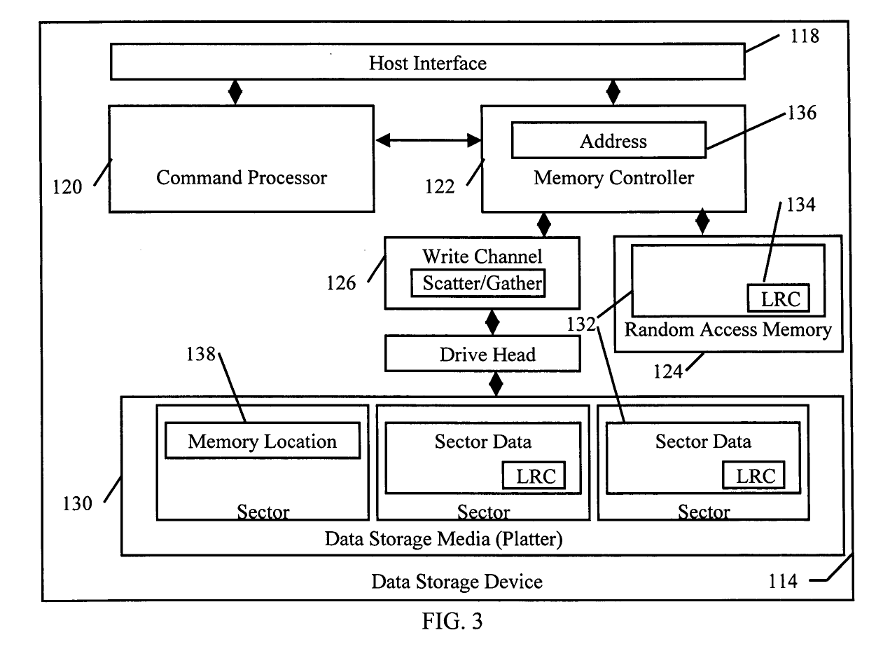

The data storage device 114 is more fully illustrated by the block diagram of FIG. 3. Here, the data storage device 114 includes a host interface 118, a command processor 120, a memory controller 122, a random access memory (“RAM”) 124, a write channel 126, a drive head 128, and a physical data storage media such as a hard disk drive platters 130. The data storage media is segregated into sectors 131.

The host interface 118 is an interface between the communication bus 116 and the rest of the data storage device 114. It handles all of the protocol on the communication bus such as small-computer systems interface (“SCSI”). The host interface 118, in conjunction with the communication bus 116, act as a communication channel between the host computer 112 and the command processor 120.

The command processor 120 controls the operation of the data storage device by executing commands received from the host computer 112. The command processor 120 is typically a micro-processor, but may be a field-programmable gate array (“FPGA”), an application-specific integrated circuit (“ASIC”), complex programmable logic device (“CPLD”), general purpose central processing unit (“CPU”), or other programmable logic device. Commands arriving from the host computer 112 are decoded at the command processor 120. When a specialized initiation command 112a arrives from the host computer 112, the command processor 120 directs the memory controller 122 to prepare and execute the initiation process according to the invention.

The memory controller is a device that handles all data transfers to and from all memory location located on the driver media (platters) 130. Traditionally, these data transfers begin and end at the host computer. However, according to the invention, data transferred during the specialized initiation process will originate at the RAM 124.

The RAM 124 memory device, or other similar temporary data storage device, contains read and write buffers for data that is being transferred to and from the data storage media 130. Traditionally, the RAM acts as a large cache for data that has been requested from the data storage media 130 by the host computer 112. Additionally, the RAM 124 may hold data being written by the host computer 112 to the data storage media. In this way, if the host computer wishes to read information that was recently written to the data storage media 130, it may find a recent copy still in the RAM 124, thus reducing the time necessary to retrieve the information.

During the specialized initiation procedure, according to the invention, sector data 132 that will be written to each sector of the data storage media 130 is first configured within the RAM 124. In this manner, each sector can be written to with data originating from the RAM. In this embodiment, the specialized initiation procedure would be transparent to the data storage media, i.e., sector data 132 would be written to the data storage media in the same way as if the data had originated from the host computer 112.

Alternatively, the RAM 124 may be configured with LRC information 134 for each sector of the data storage media 130 to be initialized, the memory controller may contain an address 136 of a memory location 138 within the data storage media 130 that includes all zeroes, and the LRC values 134 are simply appended to several iterations of the contents of the memory location 138 before being written to the each sector 131 of the data storage media 130 by the write channel 126 and drive head 128. For example, an LRC consisting of the two least significant bytes of a sectors logical block address (“LBA”) may be written to the last two bytes of each sector 131, after all other bytes have been written to with binary zeroes. If a sector has an LBA address of 1A5C02, the last two bytes (02) may be written as the LRC. Alternatively, these two bytes may be written in little endian style, i.e., written so that the last significant byte (2) is precedes the more significant byte (0) in the sector 131.

The write channel 126 includes the hardware and controls for writing data from the RAM 124, or directly from the host interface 118, to the data storage media through the drive head 128. In the second embodiment of the invention, indicated above, the write channel 126 must include a scatter/gather list capability in order to combine the LRC information 134 with the data located at the memory location 138 already residing on the data storage media 130. The drive head 128 is an electromagnetic read/write device used to either record information onto the disk or read information from it. The data storage media 130, such as a disk, or platter, or a hard disk drive, is designed to store information in the form of magnetic patterns or other digitally readable format.

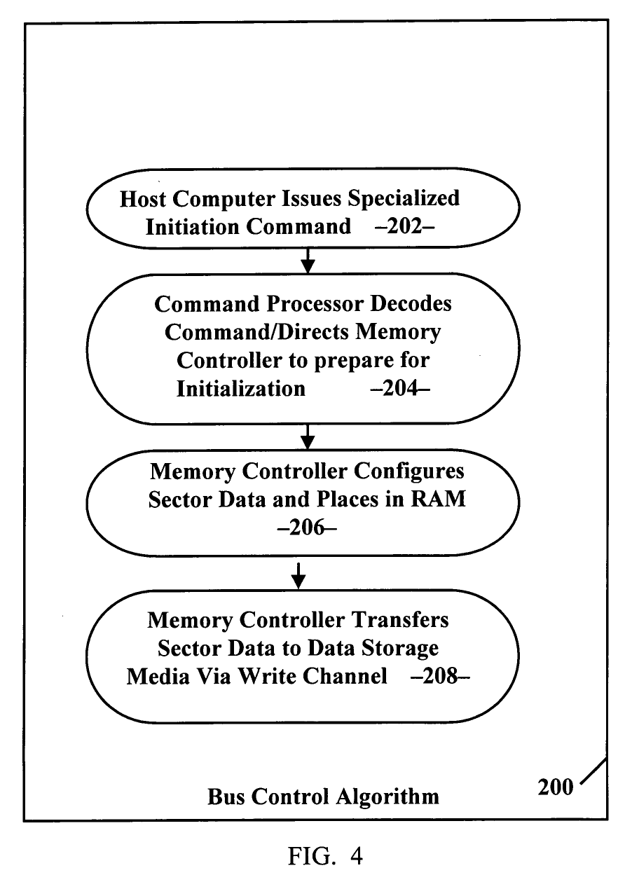

An internal initialization algorithm 200 is illustrated by the flowchart of FIG. 4. In step 202, a specialized initiation command 112a is transmitted by the host computer 112 to the command processor. The command processor decodes the specialized initiation command 112a and directs the memory controller 122 to implement the internal initialization, according to the invention, in step 204. In step 206, sector data is placed in the RAM 124 including a plurality of bytes of zeroes appended to an LRC. Alternatively, the sector data may include only the LRC information 134 for each sector 131. In step 208, the sector data is written to each sector 131 of the data storage media 130 that is the target of the specialized initiation command 112a.

Those skilled in the art of making data storage systems may develop other embodiments of the present invention. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

We claim:

1. A data storage device, comprising:
a data storage media segregated into a plurality of sectors; and
a command processor adapted to receive a specialized initiation command, to generate a plurality of corresponding sector data wherein each corresponding sector data relates to one of said sectors, and to initialize each of the plurality of sectors with its corresponding sector data.

2. The data storage device of claim 1, wherein the plurality of sector data includes logical redundancy check (“LRC”) information.

3. The data storage device of claim 1, wherein the specialized initiation command includes a format command with a unique parameter.

4. The data storage device of claim 1, wherein the specialized initiation command includes a unique send diagnostic command.

5. The data storage device of claim 1, wherein the specialized initiation command includes a write same command.

6. The data storage device of claim 1, wherein the command processor if further adapted to decode the specialized initiation command and to direct a memory controller to execute an internal initiation procedure.

7. The data storage device of claim 6, further includes a temporary memory device adapted to store the plurality of corresponding sector data.

8. The data storage device of claim 7, wherein the temporary memory device is a random access memory.

9. The data storage device of claim 6, further comprising a write channel adapted to receive the plurality of corresponding sector data from the memory controller and to write the plurality of corresponding sector data to the data storage media.

10. The data storage device of claim 9, wherein the write channel is further adapted to write the plurality of corresponding sector data to the data storage media using a scatter/gather list capability.

11. A method of providing a service for initializing a data storage device, comprising integrating computer-readable code into a computing system, wherein the computer-readable code in combination with the computing system is capable of performing the following:
receiving a specialized initiation command;
directing a memory controller to prepare for an internal initiation procedure;
writing sector data to a temporary storage device;
transferring the sector data to a write channel; and
writing the sector data to a data storage medium.

12. The method of claim 11, wherein the sector data includes logical redundancy check (“LRC”) information.

13. The method of claim 11, wherein the specialized initiation command includes a unique send diagnostic command.

14. The method of claim 12, wherein the step of writing sector data to the temporary storage device includes appending the LRC information to a plurality of binary zeroes.

15. The method of claim 12, wherein the step of writing the sector data to the data storage medium includes using a scatter/gather list capability.

16. An article of manufacture including a data storage medium, said data storage medium including a set of machine-readable instructions that are executable by a processing device to implement an algorithm, said algorithm comprising the steps of:
receiving a specialized initiation command;
directing a memory controller to prepare for an internal initiation procedure;
writing sector data to a temporary storage device;
transferring the sector data to a write channel; and
writing the sector data to a data storage medium.

17. The article of manufacture of claim 16, wherein the sector data includes logical redundancy check (“LRC”) information.

18. The article of manufacture of claim 16, wherein the specialized initiation command includes a unique send diagnostic command.

19. The article of manufacture of claim 16, wherein the step of writing the sector data to the data storage medium includes using a scatter/gather list capability.
